(19) United States
(12) Patent Application Publication
(10) Pub. No.: US 2009/0267008 A1
(43) Pub. Date: Oct. 29, 2009

(54) SOLENOID ACTUATED FLOW CONTROL VALVE INCLUDING STATOR CORE PLATED WITH NON-FERROUS MATERIAL

(75) Inventors: Michael A. LUCAS, Morgantown, IN (US); Martin W. Long, Columbus, IN (US); Donald J. Benson, Columbus, IN (US); Gary A. Garitson, Columbus, IN (US); Steven E. Ferdon, Columbus, IN (US); David M. Rix, Columbus, IN (US); Rodney A. Ewing, Columbus, IN (US); Terry L. Underwood, Seymour, IN (US)

Correspondence Address: Studebaker & Brackett PC, 1890 Preston White Drive, Suite 105, Reston, VA, 20191, US

(73) Assignee: CUMMINS INTELLECTUAL PROPERTIES, INC., Columbus, IN (US)

(21) Appl. No.: 11/855,333

(22) Filed: Sep. 14, 2007

(51) Int. Cl. F16K 31/06; H02K 15/02; H02K 33/02

(52) U.S. Cl. 251/129.15; 29/596; 310/30

(57) ABSTRACT

An electromagnetic valve includes an extra-high pressure injection system control valve having soft metal powder particles in a magnetic stator core. Electroless nickel plating is applied to the stator core to provide an intermediate surface to absorb grinding wheel stress as a working face is exposed during manufacturing, as well as an external compression layer or casing to hold or encapsulate the powder particles in place and together during assembly and use.

### FIELD OF THE INVENTION

The present invention relates generally to solenoid actuated flow controller valves including magnetic stator cores. More particularly, the present invention relates to a method and apparatus for encapsulating a magnetic stator core of a solenoid actuated flow controller valve with a non-ferrous material plating to provide increased structural support and reliability.

### BACKGROUND OF THE INVENTION

Electromagnetically actuated control valves are widely used in fuel injectors and timing fluid/injection fuel metering systems for precisely controlling the timing and metering of the injected fuel as well as timing fluid. Precise control of the timing and metering of fuel as well as timing fluid is necessary to achieve maximum efficiency of the fuel system of an internal combustion engine. This requires valve designers to consider these performance requirements in their designs. In addition, valve designers continually attempt to reduce the size of the control valves to reduce the overall size and weight of the engine and permit the control valves to be easily mounted in a variety of locations on the engine without exceeding packaging restraints.

Another concern of valve designers is magnetic stator core sloughing or chipping during operation of the valve containing the core due to fluid erosion from turbulent fuel flow. Sloughing or chipping also occurs when surface finishing the stator core by a grinding process applied to the bottom surface of the stator core in order to set the stator core-armature air gap. Magnetic stator cores are often included in a solenoid type actuator assembly. The magnetic stator cores are often made of a soft powdered magnetic (iron) metal core material which may be susceptible to sloughing or chipping during the manufacture grinding process and during use. An oxide coating may be used. The sloughing is exacerbated by the oxide film which has a negative effect of preventing a metallurgical bond to form between the individual powder particles. The mechanical and chemical bonds between the pressed particles are week and easily broken.

U.S. Pat. No. 7,156,368 B2 issued to Lucas et al. and assigned to the assignees of the present invention discloses a solenoid actuated controller valve that includes a valve plunger, a valve actuator assembly, and a solenoid assembly including a magnetic stator core.

U.S. Pat. No. 6,564,443 B2 issued to Oishi et al. and assigned to Denso Corporation discloses a solenoid actuated apparatus that includes a yoke, an attracting member, an accommodating member, a coil and a plunger. The yoke, attracting member and accommodating member form a stator core. Oishi et al. further discloses nickel-phosphorus plating is provided on an inner wall of the accommodating member to reduce sliding resistance between the plunger and the inner wall of the accommodating member.

U.S. Pat. No. 6,669,166 B2 issued to Enomoto et al. and assigned to Nippon Soken, Inc. and Denso Corporation discloses a valve body as an armature and the use of electroless nickel, diamond-like carbon (DLC) coating and nitriding as a means for wear resistance.

Consequently, there is a need for a solenoid actuated flow controller valve and the like which avoids the limitations of the prior art flow controller valves having magnetic stator cores. In addition, there also exists an unfulfilled need for such a flow controller valve that minimizes or resists magnetic stator core sloughing or chipping during manufacture and while in use.

### SUMMARY OF THE INVENTION

The foregoing needs are met, to a great extent, by the present invention, wherein in one aspect an apparatus is provided that in some embodiments utilizes a magnetic stator core plated/encapsulated with a non-ferrous material in which the non-ferrous plating reinforces the typically soft powdered metal material of the magnetic stator core and acts as an encapsulate to provide structural support to the edges and body of the magnetic stator core thereby increasing the reliability and strength of the stator core.

In accordance with one aspect of the present invention, provides a method of manufacturing a magnetic stator core of an electromagnetic operating apparatus including providing a magnetic stator core formed of an pressed magnetic metal material, including a first annular leg extending circumferentially around a central aperture, a second annular leg extending circumferentially around a coil cavity, a working face and an opposite face, plating the first and second annular legs of the magnetic stator core with a non-ferrous material plating, the non-ferrous material plating covering the working face, the opposite face, the central aperture and the coil cavity; and removing the non-ferrous material plating from the working face of the non-ferrous material plated magnetic stator core to expose the surface of magnetic material of the magnetic stator core.

In accordance with another aspect of the present invention, a flow control valve for controlling the flow of fuel in a fuel system is provided including a housing including a fuel passage; a valve movable toward a closed position to block fuel flow through the fuel passage, and toward an open position to permit fuel flow through the fuel passage; and an actuator positioned in the housing and selectively operable to move the valve, the actuator including a solenoid assembly including a magnetic stator core, a coil capable of being energized to move the valve plunger into the retracted position and an armature connected to the valve plunger for movement with the valve plunger toward the extended position, wherein the magnetic stator core is encapsulated with a non-ferrous material.

In accordance with still another aspect of the present invention, a flow control valve for controlling the flow of fuel in a fuel system is provided including an armature housing including a fuel passage; a valve plunger engaging the fuel passage, the valve plunger being adapted to reciprocally move between an extended position, and to a retracted position; and a solenoid assembly actuable to move the valve plunger into the retracted position, the solenoid assembly including an armature connected to the valve plunger for movement with the valve plunger toward the extended position and a non-ferrous encapsulated magnetic stator core, the armature further being adapted to disengage from the valve plunger.

These and other advantages and features of the present invention will become more apparent from the following detailed description of the preferred embodiments of the present invention when viewed in conjunction with the accompanying drawings.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions to such an extent as they do not depart from the spirit and scope of the present invention.

### BRIEF DESCRIPTION OF THE DRAWINGS

FIG. 1A is a perspective view of a solenoid actuated flow controller valve in accordance with one embodiment of the present invention.

FIG. 1B is a cross sectional view of the solenoid actuated flow controller valve of FIG. 1A including a magnetic stator core encapsulated with non-ferrous material plating.

FIG. 1C is an enlarged cross sectional view of a portion of the solenoid actuated flow controller valve shown in FIG. 1B that more clearly illustrates the magnetic stator core encapsulated with non-ferrous material plating feature of the present invention.

FIG. 2 is a diagrammatic illustration of the magnetic stator core encapsulated with a non-ferrous material plating of FIG. 1C, including a depiction of a grinding wheel process step as applied in the present invention.

FIG. 3 is a perspective view illustrating the magnetic stator core encapsulated with non-ferrous material plating prior to assembly within the solenoid actuated flow controller valve according to one embodiment of the invention.

FIG. 4 is a perspective cross sectional view of FIG. 3 illustrating the magnetic stator core encapsulated with non-ferrous material plating.

FIG. 5 is a flowchart illustrating the method of encapsulating the magnetic stator core with non-ferrous material plating.

### DETAILED DESCRIPTION

The invention will now be described with reference to the drawing figures, in which like reference numerals refer to like parts throughout. An embodiment in accordance with the present invention provides a solenoid actuated flow controller valve including a magnetic stator core plated/encapsulated with a non-ferrous material.

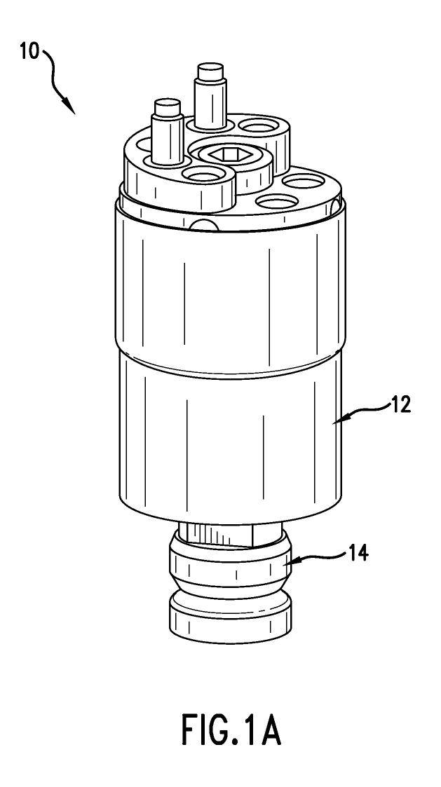

Referring to FIGS. 1A and 1B, the solenoid actuated flow controller valve 10 includes a typical valve housing 12 and a lower armature housing 14. As shown in FIG. 1B, solenoid actuated flow controller valve 10 is provided with a magnetic stator core feature 46 such as that generally disclosed in U.S. Pat. No. 7,156,368 to Lucas et al. discussed above, the contents of which are incorporated herein by reference.

In particular, as most clearly shown in the cross sectional views of FIGS. 1B and 1C, flow controller valve 10 generally includes valve housing 12, valve plunger 24 mounted for reciprocal movement in valve housing 12, valve actuator assembly 16 for selectively moving valve plunger 24 between extended and retracted positions, and a stator assembly indicated generally at 36 which includes a stator body 34 and a stator core 46. The flow controller valve 10 further may include an armature overtravel feature 18. Valve housing 12 includes upper portion 20 containing cavity 22 and lower armature housing 14 mounted in compressive abutment against a lower surface of upper portion 20. Upper portion 20 may include fuel passages 26 extending radially therethrough for communication with respective fuel passages for delivering fuel, for example, from a drain fuel source to an injector body and nozzle assembly (not shown) mounted adjacent to armature housing 14. In this regard, flow control valve 10 is preferably utilized in a fuel system and, in the preferred embodiment of FIGS. 1A to 1C, is readily positionable in the upper portion of a fuel injector (not shown).

Valve actuator assembly 16 includes solenoid assembly 30 having coil 32 mounted on bobbin 31. Coil 32 and bobbin 31 are positioned in an annular coil cavity 33 formed in stator core 46 and opening on an inner face of stator core 46. Stator core 46 includes a first annular leg 70 positioned on an inner side of cavity 33 and a second annular leg 72 positioned on an outer side of cavity 33. Coil 32 and bobbin 31 extend annularly around cavity 33 between legs 70 and 72. Solenoid assembly 30 is positioned in cavity 22 and securely attached to upper portion 20 of valve housing 12, preferably, by a metallic stator body 34. Valve plunger 24 is mounted for reciprocal movement in an aperture 25 extending through stator body 34. A spring retainer and stop device 38 is mounted on an outer end of valve plunger 24 for receiving bias spring 28 for biasing valve plunger 24 downwardly as shown in FIG. 1B.

Valve actuator assembly 16 further includes recess cavity 45 that is open toward coil 32 and stator assembly 36, and houses armature 40, disk spring 42, solenoid spacer 74, and components of overtravel feature 18. Valve plunger 24 extends through recess cavity 45. In contrast to the flow control valve disclosed in Lucas et al. in which the magnetic stator core is not encapsulated with a non-ferrous material plating, flow controller valve 10 which advantageously minimizes eddy currents, is provided with a magnetic stator core 46 plated/encapsulated with a non-ferrous material plating 50.

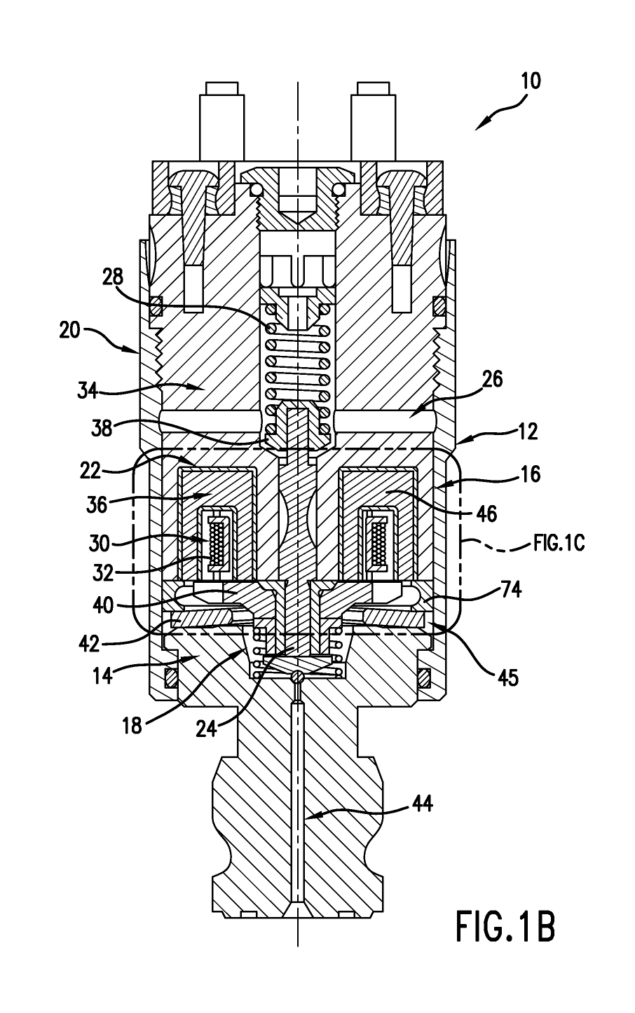

Referring to FIG. 2 in particular, stator 46 may be formed of an oxide coating. The oxide coating may be used on individual powder particles/grains 47, that are hot pressed together. The powdered metal material is pressed together in a conventional manner to form the stator core. It should be noted that the oxide coating, whose function is to provide insulation against eddy current heating, has the negative effect of preventing a metallurgical bond forming between the individual powder particles. Therefore, the mechanical and chemical bonds between pressed powder particles 47 are weak and easily broken leading to sloughing or chipping, particularly within region 48 of the magnetic stator core 46 when exposed to core stresses generated by assembly load, thermal expansion and/or hydraulic pressure pulses. However, encapsulating magnetic stator core 46 with non-ferrous material plating 50 provides an intermediate surface to absorb the stresses of grinding wheel 54 during manufacturing of magnetic stator core 46, as well as the external compression layer or plating 50 to hold or encapsulate the soft magnetic metal powder particles/material 47 in place and together, particularly at edge portions 52 of stator core 46. During the processing of stator core 46, grinding wheel 54 is longitudinally spaced a distance (a) from an outer side to an inner side of stator core 46 while moving transversely across the face of the inner side of stator core 46 to form the inner working face 78 which is oriented the distance (a) from an opposite face 76 of the stator core 46.

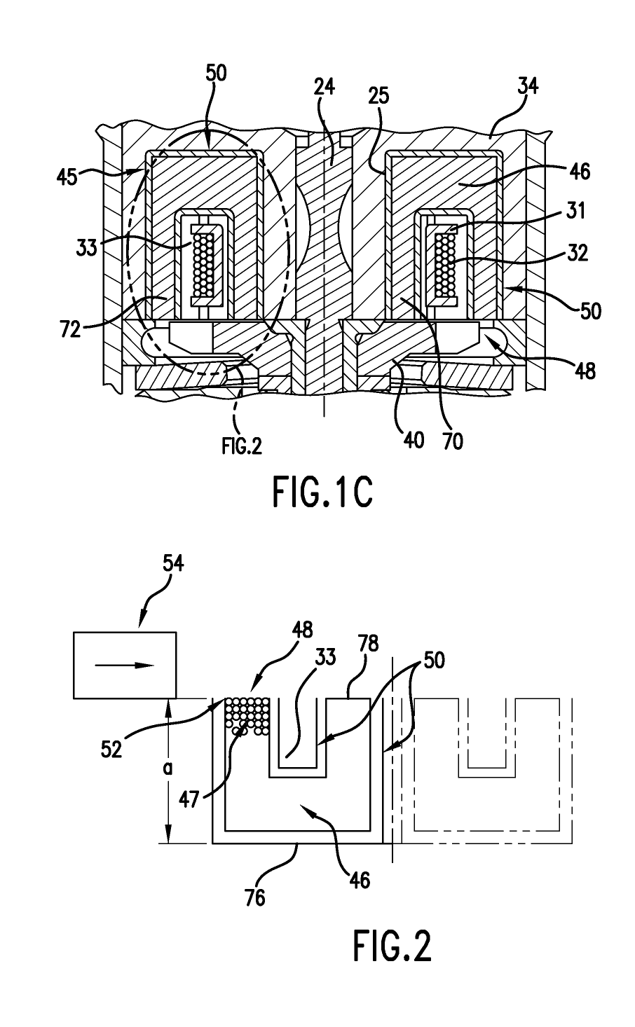

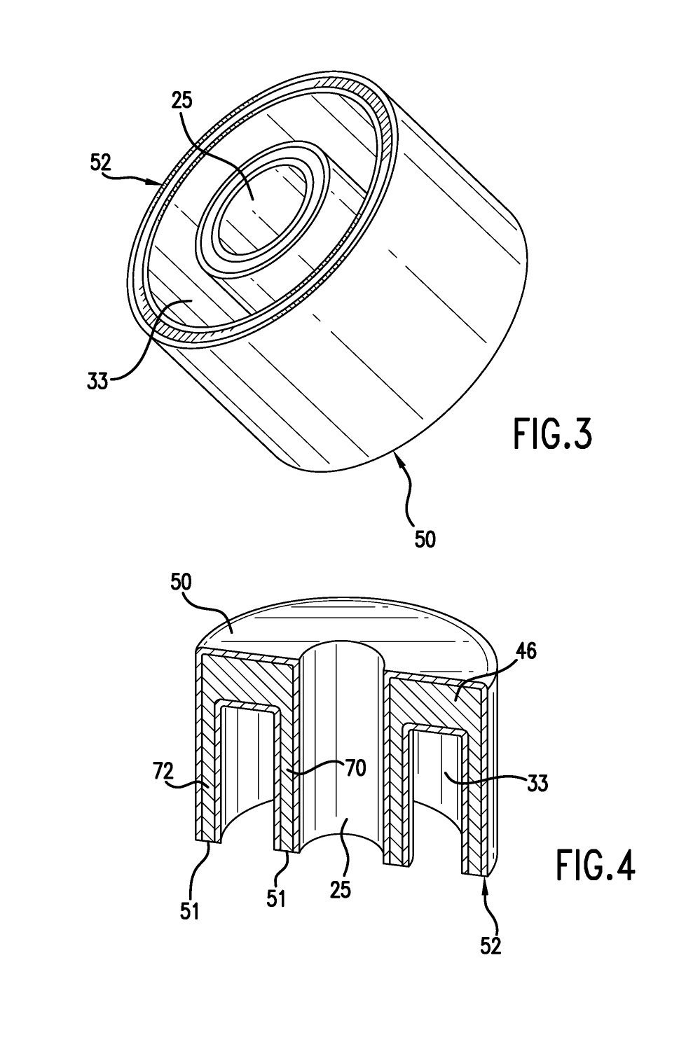

Referring to FIGS. 3 and 4, the magnetic stator core 46 is illustrated after being encapsulated with a non-ferrous material plating 50 and after abrading or grinding plating 50 from inner working face 78 forming flat end surfaces 51 as shown in FIG. 2 to expose soft magnetic material 47 on end surfaces 51 prior to assembly within flow controller valve 10 as shown in FIG. 1B. It should be noted that edge portions 52 maintain plating 50 to provide edge support to soft magnetic material 47.

Referring again to FIGS. 1A to 1C, solenoid actuated flow controller valve 10 in accordance with one example embodiment of the present invention provides various advantages over flow controller valves of the prior art. As explained above, solenoid actuated flow controller valve 10 minimizes sloughing or chipping of magnetic stator core 46 by applying a plating 50 made of a non-ferrous material to encapsulate the stator core 46. This non-ferrous plating material preferably is nickel. Plating 50 increases the reliability and structural integrity of stator core 46 along with a strengthening of exposed edge or corner portions 52 of stator core 46 during operation of flow controller valve 10, for example, the flow of fuel through a fuel injection system in an internal combustion engine.

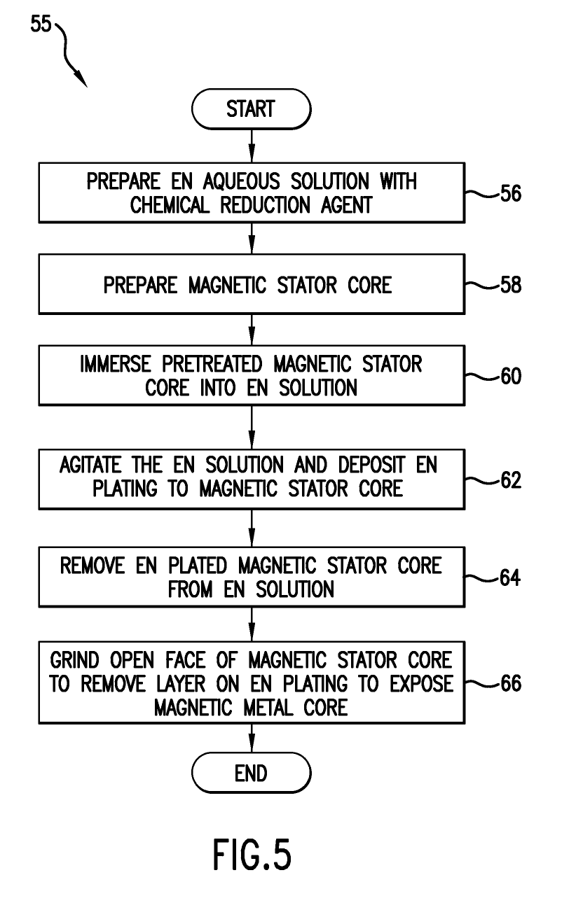

Referring to FIG. 5, a preferred electroless plating process 55 is utilized to plate stator core 46 is electroless nickel (EN) plating. electroless nickel plating is a chemical reduction process which depends upon the catalytic reduction process of nickel ions in an aqueous solution (containing a chemical reduction agent) and the subsequent deposition of nickel metal without the use of electrical energy. Due to its exceptional corrosion resistance and high hardness, process 55 can be used in many applications on items such as valves, pump parts, etc., to enhance the life of components exposed to severe conditions of service, particularly in the oil field and marine sector. With the correct pretreatment sequence and accurate process control, good adhesion and excellent service performance can be obtained from electroless nickel deposited on a multitude of metallic and non-metallic substrates.

In the electroless nickel plating process 55, the electroless nickel aqueous solution is prepared in step 56, and the object or part to be electroless nickel plated is pretreated in step 58 and then immersed into the aqueous solution in step 60. Next, the electroless nickel aqueous solution is agitated and electroless nickel plating is deposited in step 62 on the object or part. The electroless nickel plated object or part is removed in step 64 from the electroless nickel aqueous solution and, after a predetermined time period to allow electroless nickel plate hardening, the electroless nickel plated object or part is ground or abraded in step 66 on a side surface to remove a layer of electroless nickel plating on that side surface and expose the material of the object or part. The driving force for the reduction of nickel metal ions and their deposition is supplied by a chemical reducing agent in solution in step 56. This driving potential is essentially constant at all points of the surface of the component, provided the agitation step 62 is sufficient to ensure a uniform concentration of metal ions and reducing agents. Electroless deposits are therefore very uniform in thickness all over the shape and size of the plated part or object. Process 55 offers distinct advantages when plating irregularly shaped objects, holes, recesses, internal surfaces, valves or threaded parts.

During final processing by way of example, nickel/non-ferrous plating 50 may be ground off as in step 66 of the magnetic face 51 of stator core 46. Nickel/non-ferrous plating 50 may be configured to provide added support along the sharp edges 52 of nickel/non-ferrous plated magnetic stator core 46. Nickel/non-ferrous plated magnetic stator core 46 may be configured to be installed within solenoid actuated controller valve 10. Nickel/non-ferrous plated or encapsulated magnetic stator core 46 utilizes nickel/non-ferrous plating 50 to reinforce soft powdered metal material 47 of magnetic stator core 46 and acts as an encapsulate to provide structural support to edge portions 52 and body of magnetic stator core 46.

Distinct advantages of EN plating are: 1) Uniformity of the deposits, even on complex shapes; 2) Deposits are often less porous and thus provide better barrier corrosion protection to steel substrates, much superior to that of electroplated nickel and hard chrome, 3) The deposits cause about ⅕th as much hydrogen absorption as electrolytic nickel and about 1/10th as much hard chrome, 4) Deposits can be plated with zero or compressive stress, 5) Deposits have inherent lubricity and non-galling characteristics, unlike electrolytic nickel, 6) Deposits have good wetability for oils, 7) In general low phosphorus and especially electroless nickel boron are considered solderable. Mid and high phosphorus EN's are far worse for solderability and 8) Deposits are much harder with as-plated microhardness of 450-600 VHN which can be increased to 1000-1100 VHN by a suitable heat-treatment.

Thus, during operation, to actuate flow controller valve 10, solenoid assembly 30 is provided with an electrical signal from an electronic control module (ECM—not shown) via a terminal connection at a predetermined time to energize solenoid assembly 30. This causes armature 40 and valve plunger 24 to move from the extended position shown in FIG. 1C, upwardly for a stroke distance to a retracted position to thereby allow fuel flow through fuel passage 44.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. A method of manufacturing a magnetic stator core of an electromagnetic operating apparatus, comprising:
providing a magnetic stator core formed of an pressed magnetic metal material, including a first annular leg extending circumferentially around a central aperture, a second annular leg extending circumferentially around a coil cavity, a working face and an opposite face,
plating said first and second annular legs of said magnetic stator core with a non-ferrous material plating, said non-ferrous material plating covering the working face, the opposite face, the central aperture and the coil cavity; and
removing the non-ferrous material plating from the working face of the non-ferrous material plated magnetic stator core to expose the surface of magnetic material of the magnetic stator core.

2. The method of claim 1, wherein the plating step further comprises:
preparing an electroless non-ferrous material aqueous solution including a chemical reduction agent;
pretreating the magnetic stator core for electroless non-ferrous material plating;
immersing the pretreated stator core into the aqueous solution;
agitating the aqueous solution to deposit the electroless non-ferrous material plating to the magnetic stator core; and
removing the non-ferrous plated stator core from the aqueous solution.

3. The method of claim 2, wherein the non-ferrous material is nickel.

4. The method of claim 2, wherein the pressed magnetic metal material comprises powdered grains.

5. The method of claim 4, wherein the powdered grains each include an oxide insulating layer.

6. The method of claim 1, wherein the removing step further includes abrading the working face to expose the magnetic material of the stator core.

7. A flow control valve for controlling the flow of fuel in a fuel system, comprising:
a housing including a fuel passage;
a valve movable toward a closed position to block fuel flow through said fuel passage, and toward an open position to permit fuel flow through said fuel passage; and
an actuator positioned in said housing and selectively operable to move said valve, said actuator including a solenoid assembly including a magnetic stator core, a coil capable of being energized to move said valve plunger into said retracted position and an armature connected to said valve plunger for movement with said valve plunger toward said extended position,
wherein the magnetic stator core is encapsulated with a non-ferrous material.

8. The flow control valve of claim 7, wherein the non-ferrous material is nickel.

9. The flow control valve of claim 7, wherein said housing includes a recess cavity for receiving an armature, said recess cavity including an inner bottom surface.

10. The flow control valve of claim 7, wherein the magnetic stator core is encapsulated by electroless nickel plating.

11. The flow control valve of claim 8, wherein the magnetic stator core is abraded at a working face located adjacent the armature to expose magnetic material at said working face.

12. The flow control valve of claim 11, wherein the magnetic material comprises powdered grains.

13. The flow control valve of claim 12, wherein the powdered grains each include an oxide insulating layer.

14. The flow control valve of claim 11, wherein the abraded working face is a predetermined distance from an opposite face of the magnetic stator core.

15. A flow control valve for controlling the flow of fuel in a fuel system, comprising:
an armature housing including a fuel passage;
a valve plunger engaging said fuel passage, said valve plunger being adapted to reciprocally move between an extended position, and to a retracted position; and
a solenoid assembly actuable to move said valve plunger into said retracted position, said solenoid assembly including an armature connected to said valve plunger for movement with said valve plunger toward said extended position and a non-ferrous encapsulated magnetic stator core, said armature further being adapted to disengage from said valve plunger.

16. The flow control valve of claim 15, wherein the magnetic stator core is encapsulated by electroless nickel plating.

17. The flow control valve of claim 16, wherein the magnetic stator core is abraded at a working face located adjacent the armature to expose magnetic material at said working face.

18. The flow control valve of claim 17, wherein the magnetic material comprises powdered grains.

19. The flow control valve of claim 18, wherein the powdered grains each include an oxide insulating layer.

20. The flow control valve of claim 17, wherein the abraded working face is a predetermined distance from an opposite face of the magnetic stator core.
